(19) United States
(12) Patent Application Publication
(10) Pub. No.: US 2007/0008945 A1
(43) Pub. Date: Jan. 11, 2007

(54) Apparatus and method for IIP3 control for a wireless transceiver

(75) Inventors: Young-II Son, Hwaseong-si (KR); Woo Yong Lee, Seongnam-si (KR); Hyung-Weon Park, Seoul (KR); Chul-Jin Kim, Yongin-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd.

(21) Appl. No.: 11/455,142

(22) Filed: Jun. 16, 2006

(30) Foreign Application Priority Data
Jul. 5, 2005 (KR) 10-2005-0060234

(51) Int. Cl. H04B 7/208

(52) U.S. Cl. 370/344

(57) ABSTRACT

Disclosed is an apparatus for controlling the input 3^{rd} order Intercept Point (IIP3) in a multi-mode multi-band wireless transceiver. The apparatus includes: a mixer for down-converting an incoming wireless signal which is received through each frequency band and is then low noise-amplified; a baseband chip for providing mixer IIP3 control information according to a current mode and transmission power level of the wireless transceiver; and a mixer IIP3 controller for controlling the IIP3 of the mixer based on the IIP3 control information. In a wireless transceiver without a band pass filter between a low noise amplifier and a mixer, the apparatus does not always increase the IIP3 of the mixer, but increases the IIP3 of the mixer in a wireless transceiver only when it is necessary to increase the IIP3. Therefore, the apparatus can reduce wasteful power consumption.

### PRIORITY

This application claims the benefit under 35 U.S.C. §119(a) of an application entitled “Apparatus And Method For IIP3 Control For A Wireless Transceiver” filed in the Korean Industrial Property Office on Jul. 5, 2005 and assigned Serial No. 2005-60234, the contents of which are incorporated herein by reference.

### BACKGROUND OF THE INVENTION

1. Field of the Invention

The present invention relates generally to a wireless transceiver, and in particular, to an apparatus and a method for controlling the Input 3^{rd} order Intercept Point (IIP3) of a mixer in order to reduce power consumption in a multi-mode multi-band wireless transceiver.

2. Description of the Related Art

In light of the more recent development of wireless transceivers used for supporting multiple modes and multiple bands, it is possible to use various mobile communication services of countries worldwide by a single mobile communication terminal.

In general, a multi-mode multi-band wireless transceiver has an individual wireless transceiver for each band, in order to support various mobile communication services, such as Code Division Multiple Access (CDMA), Wideband Code Division Multiple Access (WCDMA), Global System for Mobile communication (GSM)/General Packet Radio Service (GPRS)/Enhanced Data rates for GSM Evolution (EDGE), etc. Particularly, since the CDMA and WCDMA services employing a Frequency Division Duplexing (FDD) scheme use different frequency bands for transmission/reception, the FDD CDMA or WCDMA service requires an individual transceiver for each band corresponding to the CDMA or WCDMA service.

FIG. 1 illustrates conventional receivers for multiple bands, each of which supports a WCDMA service. The receivers shown in FIG. 1 include a WCDMA 2000 MHz receiver 10, a WCDMA 1900 MHz receiver 20, and a WCDMA 850 MHz receiver 30.

As noted from FIG. 1, each of the conventional receivers includes a Low Noise Amplifier (LNA) 1 for amplifying an incoming signal, a mixer 3 for down-converting the incoming signal, a band pass filter 2 located between the LNA 1 and the mixer 3.

The low pass filter 2 attenuates various noise signals including the incoming signal component transmitted from a transmitter from among the incoming signal input to the LNA 1 and allows only a signal of the corresponding band to pass through the filter 2 to the mixer 3. Therefore, the band pass filter 2 prevents, to some degree, the transmission signal and the noise signal from being inter-modulated with a jammer in the mixer 3 and thus from being introduced through the reception band.

However, the band pass filter 2 installed in each receiver requires additional cost and occupies a large area. Therefore, the band pass filter 2 disposed between the LNA 1 and the mixer 3 makes it difficult to reduce the size and price of the wireless transceiver.

Meanwhile, in order to avoid use of the band pass filter 2, it is necessary to raise the IIP3 by the variance corresponding to the amount of attenuation by the conventional band pass filter 2.

However, the mixer 3 does not always require a high IIP3. For example, a service of the Time Division Duplexing (TDD) scheme, such as GSM/GPRS/EDGE, does not require a high IIP3 because the transmission and reception do not simultaneously occur in the TDD service, differently from the services of the FDD scheme, such as CDMA or WCDMA, in which transmission and reception simultaneously occur. Further, the service of the FDD scheme also does not require a high IIP3 either in an idle mode in which the transmitter does not operate or when the transmission power is not large.

Therefore, if the IIP3 of the mixer 3 is unconditionally increased by the variance corresponding to the amount of attenuation by the conventional band pass filter 2, in compensation for elimination of the band pass filter 2, such an increase of the IIP3 causes wasteful consumption of electric current when it is unnecessary to increase the IIP3.

### SUMMARY OF THE INVENTION

Accordingly, the present invention has been made to solve the above-mentioned problems occurring in the prior art, and an object of the present invention is to provide an apparatus and a method for IIP3 control, which can reduce wasteful power consumption by increasing the IIP3 of a mixer in a wireless transceiver only when it is necessary to increase the IIP3.

It is another object of the present invention to provide an apparatus and a method for IIP3 control, which can reduce wasteful power consumption by controlling the IIP3 of a mixer in a wireless transceiver according to the transmission power.

In order to accomplish this object, there is provided an apparatus for control of Input 3^{rd} order Intercept Point (IIP3) in a multi-mode multi-band wireless transceiver, the apparatus having a mixer for down-converting an incoming wireless signal which is received through each frequency band and is then low noise-amplified; a baseband chip for providing mixer IIP3 control information according to a current mode and transmission power level of the wireless transceiver; and a mixer IIP3 controller for controlling the IIP3 of the mixer based on the IIP3 control information.

In accordance with another aspect of the present invention, there is provided a method for control of Input 3^{rd} order Intercept Point (IIP3) in a multi-mode multi-band wireless transceiver, the method includes determining a current mode and transmission power level of the wireless transceiver by a baseband chip; providing mixer IIP3 control information according to the determined current mode and transmission power level; and controlling the IIP3 of a mixer based on the IIP3 control information by a mixer IIP3 controller.

In accordance with still another aspect of the present invention, there is provided an apparatus for control of Input 3^{rd} order Intercept Point (IIP3) in a wireless transceiver, the apparatus having a mixer for down-converting an incoming signal which has been low noise-amplified; a baseband chip for providing mixer IIP3 control information according to transmission power level of the wireless transceiver; and a mixer IIP3 controller for controlling the IIP3 of the mixer based on the IIP3 control information.

In accordance with yet still another aspect of the present invention, there is provided a method for control of Input 3^{rd} order Intercept Point (IIP3) in a wireless transceiver, the method includes determining transmission power level of the wireless transceiver by a baseband chip; providing mixer IIP3 control information according to the determined transmission power level; and controlling the IIP3 of a mixer based on the IIP3 control information by a mixer IIP3 controller.

### BRIEF DESCRIPTION OF THE DRAWINGS

The above and other objects, features and advantages of the present invention will be more apparent from the following detailed description taken in conjunction with the accompanying drawings, in which:

FIG. 1 illustrates conventional receivers for multiple bands, each of which supports a WCDMA service;

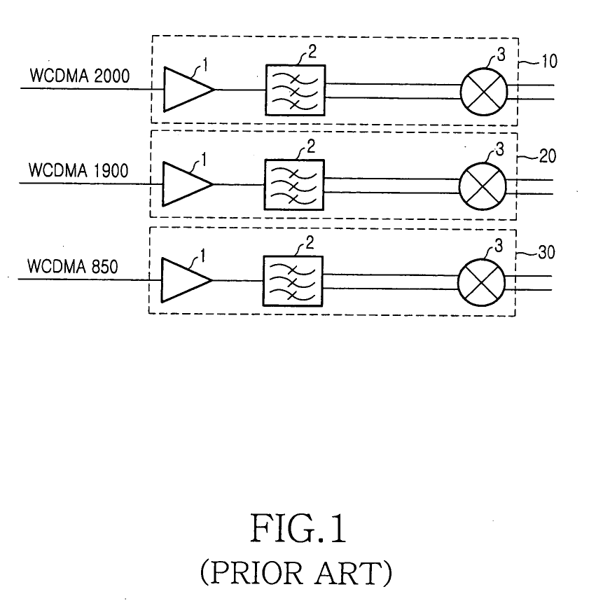

FIG. 2 is a block diagram schematically illustrating a multi-mode multi-band wireless transceiver according to an embodiment of the present invention;

FIGS. 3A and 3B are graphs illustrating jammers in a mixer according to the present invention;

FIG. 4 is a graph illustrating generation of the 3^{rd} Order Intermodulation (IM3) in a mixer according to an embodiment of the present invention;

FIG. 5 is a circuit diagram illustrating the structure of a mixer according to the present invention;

FIG. 6 illustrates an example of the IIP3 control information of a mixer according to the present invention; and

FIG. 7 is a flowchart illustrating a method for IIP3 control by a multi-mode multi-band wireless transceiver according to the present invention.

### DETAILED DESCRIPTION OF THE PREFERRED EMBODIMENTS

Hereinafter, preferred embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

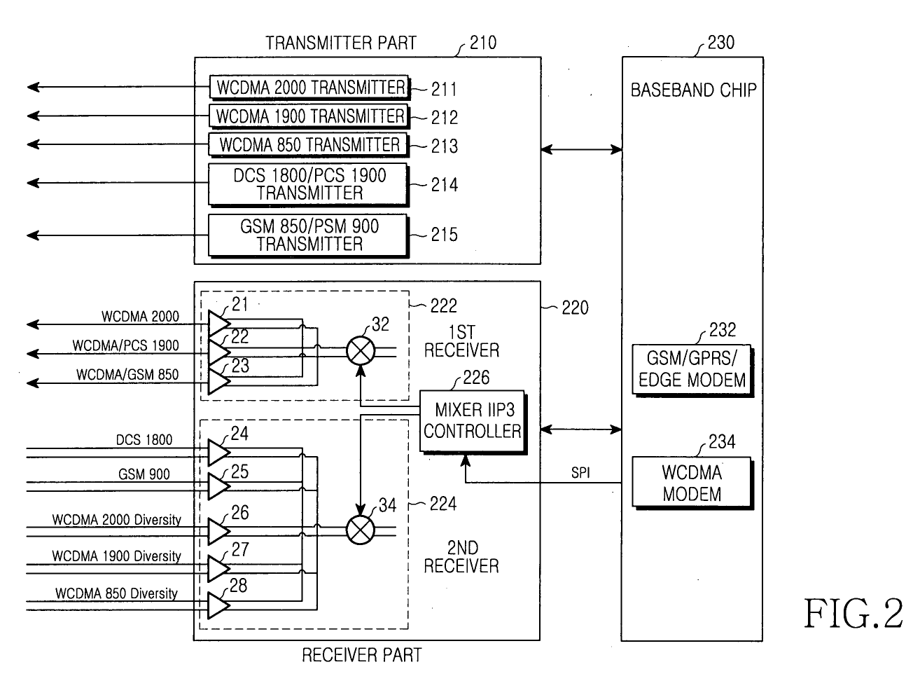

FIG. 2 is a block diagram schematically illustrating a multi-mode multi-band wireless transceiver according to the present invention. The multi-mode multi-band wireless transceiver shown in FIG. 2 includes a transmitter part 210, a receiver part 220, and a baseband chip 230.

The transmitter part 210 includes multiple transmitters for the multiple modes and multiple bands, which transmit signals corresponding to the multiple modes and multiple bands, respectively. Specifically, the transmitter part 210 includes a WCDMA 2000 transmitter 211, a WCDMA 1900 transmitter 212, and a WCDMA 850 transmitter 213 for transmitting wireless signals of the FFD scheme, and a DCS 1800/PCS 1900 transmitter 214 and a GSM 850/PSM 900 transmitter 215 for transmitting wireless signals of the TDD scheme.

The WCDMA 2000 transmitter 211 outputs an outgoing signal of the 2000 MHz band in the WCDMA mode. The WCDMA 1900 transmitter 212 outputs an outgoing signal of the 1900 MHz band in the WCDMA mode. The WCDMA 850 transmitter 213 outputs an outgoing signal of the 850 MHz band in the WCDMA mode. The Digital Cordless System (DCS) mode 1800/PCS 1900 transmitter 214 outputs an outgoing signal of the 1800 MHz bandwidth in the DCS mode and an outgoing signal of the 1900 MHz bandwidth in the Personal Communication System (PCS) mode. The GSM 850/PSM 900 transmitter 215 outputs outgoing signals of the 850 MHz band and the 900 MHz band in the GSM mode.

The receiver part 220 includes multiple receivers for the multiple modes and multiple band, which receive wireless signals corresponding to the multiple modes and multiple band, respectively. Specifically, the receiver part 220 includes a first receiver 222, a second receiver 224, and a mixer IIP3 controller 226.

The first receiver 222 is a main receiver for receiving wireless signals of main band, such as bandwidths of WCDMA 2000 MHz, WCDMA 1900 MHz, WCDMA 850 MHz, GSM/GPRS/EDGE 1900 MHz, and GSM/GPRS/EDGE 850 MHz. The first receiver 222 includes first to third LNAs 21 to 23 for receiving and low noise-amplifying the main band signals and a first mixer 32 for down-converting the signals amplified by the LNAs from the high frequency band to the low frequency band.

The first LNA 21 amplifies an incoming signal of the 2000 MHz band in the WCDMA mode. The second LNA 22 amplifies an incoming signal of the 1900 MHz band in the WCDMA mode and the PCS mode. The third LNA 23 amplifies an incoming wireless signal of the 850 MHz band in the WCDMA mode and the GSM mode. The first mixer 32 down-converts the signals amplified by the first to third LNAs 21 to 23 from the high frequency band to the low frequency band.

The second receiver 224 is a sub-receiver for receiving signals of sub-bands, such as bandwidths of GSM/GPRS/EDGE 1900 MHz and GSM/GPRS/EDGE 850 MHz, and the diversity band. The second receiver 224 includes fourth to eighth LNAs 24 to 28 for receiving and low noise-amplifying the sub-band signals and a second mixer 34 for down-converting the signals amplified by the LNAs from the high frequency band to the low frequency band.

The fourth LNA 24 amplifies an incoming signal corresponding to the DCS 1800 MHz. The fifth LNA 25 amplifies an incoming signal corresponding to the GSM 900 MHz. The sixth LNA 26 amplifies a diversity incoming signal of the 2000 MHz bandwidth in the WCDMA mode. The seventh LNA 27 amplifies a diversity incoming signal of the 1900 MHz bandwidth in the WCDMA mode. The eighth LNA 28 amplifies a diversity incoming signal of the 850 MHz bandwidth in the WCDMA mode. The second mixer 34 down-converts the signals amplified by the fourth to eighth LNAs 24 to 28 from the high frequency band to the low frequency band.

However, each of the receivers according to the present invention as described above has no band pass filter between the LNA and the mixer. Therefore, when the outgoing signal has a large output power, various noise signals including the outgoing unfiltered signal component are input to the mixer. Such noise signals including the outgoing signal component are inter-modulated with a jammer in the mixer.

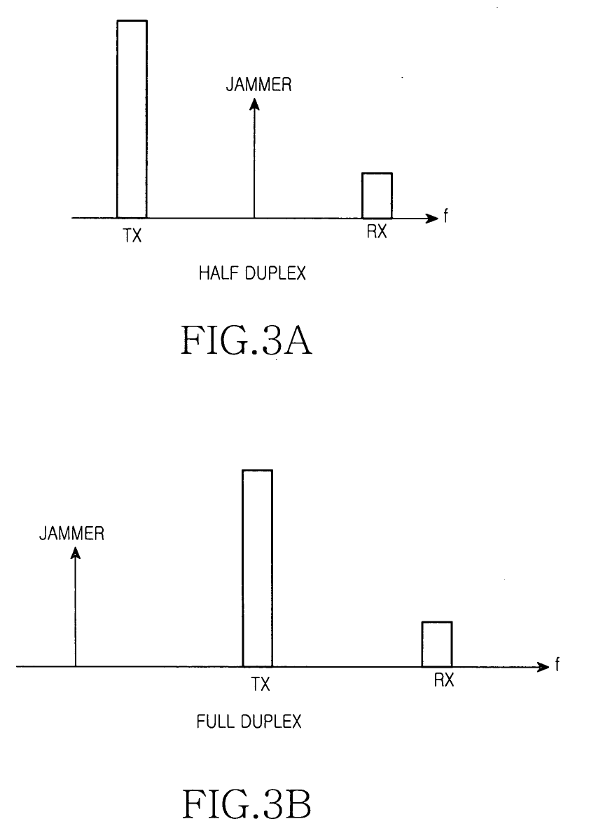

FIGS. 3A and 3B are graphs illustrating jammers in a mixer according to the present invention. The jammer shown in FIG. 3A is a half duplex jammer, and the jammer shown in FIG. 3A is a full duplex jammer.

Referring to FIG. 3A, the half duplex jammer has a jammer frequency located between a transmission (TX) frequency and a reception (RX) frequency. The jammer frequency in FIG. 3A is equal to {RX frequency−(RX frequency−TX frequency)/2 }.

Meanwhile, referring to FIG. 3B, the full duplex jammer has a jammer frequency located in a frequency band lower than the transmission (TX) frequency. The jammer frequency in FIG. 3B is equal to {TX frequency−(RX frequency−TX frequency)}.

As noted from FIGS. 3A and 3B, when a transmission signal has a large transmission power, the jammer is inter-modulated with a part of the transmission signal, so as to generate a 3^{rd} Order Intermodulation (IM3).

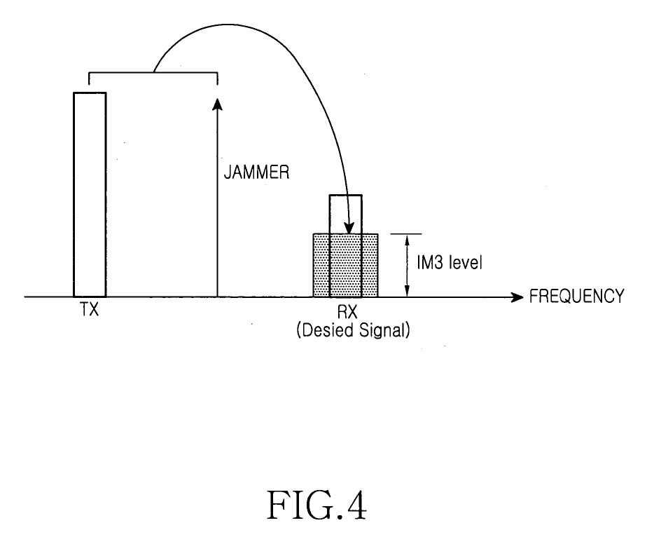

FIG. 4 is a graph illustrating generation of the IM3 in a mixer according to an embodiment of the present invention. As noted from FIG. 4, when the transmission power is strong, the transmission signal component and the jammer component are combined so as to generate an IM3 which serves as noise to the reception frequency band. Therefore, the smaller the IM3 level as shown in FIG. 4, the better the performance of the receiver.

Here, the relation between the IM3 and the IIP3 can be defined by Equation (1) below.
IM3=3 Jammer level−2 IIP3 (1)

It is noted from Equation (1) that the IM3 decreases as the IIP3 increases. Therefore, it is possible to reduce the IM3 and thus improve the performance of the receiver by increasing the IIP3.

However, when the IIP3 is increased, the power consumption increases although the performance of the receiver is improved. Therefore, in the multi-mode multi-band wireless transceiver according to the present invention, it is necessary to properly adjust the IIP3 of the mixers 32 and 34 in accordance with a required magnitude of the IIP3.

In other words, in the multi-mode multi-band wireless transceiver, services of the TDD scheme such as GSM/GPRS/EDGE, in which transmission and reception, do not simultaneously occur, do not require a high IIP3 which is required by the CDMA or WCDMA service in which transmission and reception simultaneously occur. Further, the FDD scheme does not require a high IIP3 either, when the transmission power is not high or in an idle mode in which the transmitter does not operate. Therefore, the interval during which the multi-mode multi-band wireless transceiver actually transmits a signal with a large output power occupies a small temporal proportion.

Therefore, according to the present invention, it is possible to reduce unnecessary power consumption by increasing the IIP3 of the mixer when the transmission power is large in the FDD service, while decreasing it in the other cases.

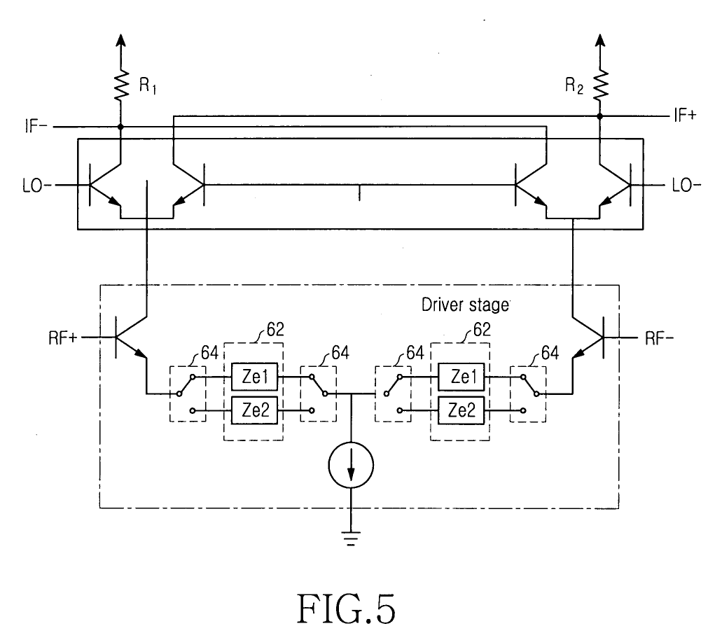

FIG. 5 is a circuit diagram illustrating the structure of a mixer according to the present invention. Referring to FIG. 5, the mixer according to the embodiment of the present invention receives an wireless signal of a high frequency band and converts it into an wireless signal of a lower frequency band. Also, as noted, the greater current flows through the emitter side, the larger the IIP3. In contrast, the less the current flows through the emitter side, the smaller the IIP3.

The mixer according to the present invention includes at least two impedances 62 including Ze1 and Ze2, which have different impedance values for controlling the magnitude of the current flowing through the emitter, and a switch 64 for selecting one of the impedances 62. By selecting one of the impedances 62 by the switch 64, it is possible to control the IIP3 of the mixer.

The description about the present invention is based on where the mixer includes two impedances including a larger impedance Ze1 and a smaller impedance Ze2. When the larger impedance Ze1 has been selected, a small quantity of current flows through the emitter side, so as to decrease the IIP3. When the smaller impedance Ze2 has been selected, a large quantity of current flows through the emitter side, so as to increase the IIP3.

Referring to FIG. 2 again, the baseband chip 230 contains information regarding whether the current operation mode is the TDD mode or the FDD mode, information regarding the magnitude of the transmission power, and IIP3 control information according to the transmission power for each mode. The baseband chip 230 provides the IIP3 control information to the mixer IIP3 controller 226 based on the transmission power for each mode. In this case, the baseband chip 230 can provide the IIP3 control information to the mixer IIP3 controller 226 through a Serial Peripheral Interface (SPI) signal.

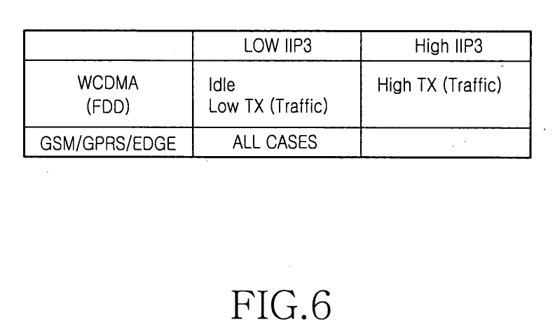

FIG. 6 illustrates an example of the IIP3 control information of a mixer according to of the present invention.

Referring to FIG. 6, first, in a TDD mode, such as the GSM/GPRS/EDGE mode, in which transmission and reception do not simultaneously occur, the IIP3 control information corresponds to LOW IIP3 in all cases.

In contrast, in the FDD mode, such as the CDMA or WCDMA mode, in which transmission and reception simultaneously occur, the IIP3 control information is determined according to the intensity of the transmission power. For example, in the FDD mode, the IIP3 control information corresponds to HIGH IIP3 when the transmission power is greater, while the IIP3 control information corresponds to LOW IIP3 when the transmission power is low or in the idle mode in which the transmitter does not operate.

The mixer IIP3 controller 226 stores the IIP3 control information provided by the baseband chip 230 in a register included in the RF chip, and controls the switch 64 of the mixers 32 and 34.

That is, in the idle state in the case of the FDD mode such as WCDMA, the transmission power is in the off state and the mixer IIP3 controller 226 thus controls the IIP3 of the mixer to be the LOW IIP3 state. Further, in the traffic state in the case of FDD mode, the mixer IIP3 controller 226 controls the IIP3 of the mixer to be the HIGH IIP3 state when the transmission power level is high, and to be the LOW IIP3 state when the transmission power level is low.

Meanwhile, in the case of non-FDD mode, such as the GSM/GPRS/EDGE mode, the IIP3 of the mixer is controlled to be the LOW IIP3 regardless of the current state.

Then, the mixer IIP3 controller 226 may control the switch 64 to select the larger impedance Ze1 from between the larger impedance Ze1 and the smaller impedance Ze2, so as to reduce the quantity of current flowing through the emitter side, thereby controlling the IIP3 of the mixer to be the LOW IIP3.

Further, the mixer IIP3 controller 226 can control the switch 64 to select the smaller impedance Ze2 from between the larger impedance Ze1 and the smaller impedance Ze2, so as to increase the quantity of current flowing through the emitter side, thereby controlling the IIP3 of the mixer to be the HIGH IIP3.

Hereinafter, a method for IIP3 control by the above-mentioned multi-mode multi-band wireless transceiver will be described.

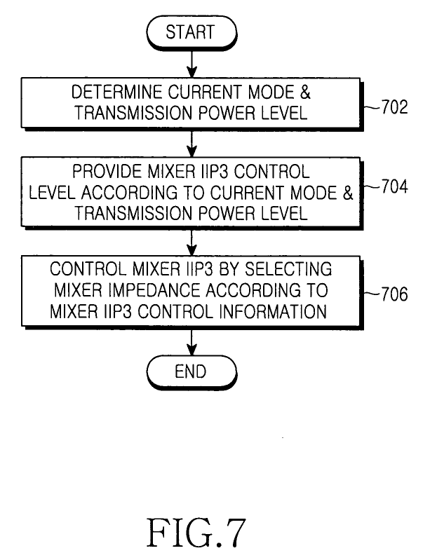

FIG. 7 is a flowchart illustrating a method for IIP3 control by a multi-mode multi-band wireless transceiver according to the present invention. Referring to FIG. 7, the baseband chip 230 determines the current mode and transmission power level of the wireless transceiver in step 702.

The baseband chip 230 determines if the current mode of the wireless transceiver is the FDD mode, and determines if the transmission power level exceeds a predetermined threshold when the current mode is the FDD mode.

After determining the current mode and transmission power level of the wireless transceiver, the baseband chip 230 provides the mixer IIP3 control information according to the current mode and transmission power level to the mixer IIP3 controller 226 in step 704.

For example, when the current mode is not the FDD mode, in which transmission and reception do not simultaneously occur, the mixer IIP3 control information provided from the baseband chip 230 to the mixer IIP3 controller 226 is the LOW IIP3 in all cases. Further, in the case where the current mode is the FDD mode, the mixer IIP3 control information provided from the baseband chip 230 to the mixer IIP3 controller 226 is the LOW IIP3 when the transmitter is in an idle state, in which the wireless transceiver does not operate, or the transmission power is low, and is the HIGH IIP3 when the transmission power is great.

Then, in step 706, the mixer IIP3 controller 226 controls the IIP3 of the mixer by selecting a corresponding impedance of the mixer according to the mixer IIP3 control information.

For example, when the IIP3 control information is the LOW IIP3, the mixer IIP3 controller 226 controls the sixth LNA 26 to select the larger impedance Ze1 from between the larger impedance Ze1 and the smaller impedance Ze2, thereby reducing the quantity of current flowing through the emitter side. Further, when the IIP3 control information is the HIGH IIP3, the mixer IIP3 controller 226 controls the sixth LNA 26 to select the smaller impedance Ze2 from between the larger impedance Ze1 and the smaller impedance Ze2, thereby increasing the quantity of current flowing through the emitter side.

According to the present invention as described above, it is possible to eliminate a low pass filter between a low noise amplifier and a mixer in multi-mode multi-band wireless transceiver as well as a single mode single band wireless transceiver, so that it is possible to reduce wasteful power consumption by increasing the IIP3 of a mixer in a wireless transceiver only when it is necessary to increase the IIP3.

Specifically, it is possible to reduce wasteful power consumption by increasing the IIP3 of the mixer when the transmission power is large and decreasing in the other cases, in the case of FDD mode in multi-mode multi-band wireless transceiver.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for control of Input 3^{rd} order Intercept Point (IIP3) in a multi-mode multi-band wireless transceiver, the apparatus comprising:
a mixer for down-converting an incoming signal wireless which is received through each frequency band and is then low noise-amplified;
a baseband chip for providing mixer IIP3 control information according to a current mode and transmission power level of the wireless transceiver; and
a mixer IIP3 controller for controlling the IIP3 of the mixer based on the IIP3 control information.

2. The apparatus as claimed in claim 1, wherein the mixer IIP3 control information according to the transmission power level and the mode has a lower value when the wireless transceiver does not employ a Frequency Division Duplexing (FDD) mode or when the transceiver employs the FDD mode and is in an idle state in which the transceiver does not operate, and has a higher value when the wireless transceiver employs the FDD mode and the transmission power is great.

3. The apparatus as claimed in claim 1, wherein the mixer comprises:
at least two impedances having different impedance values; and
a switch for selecting one of the impedances.

4. The apparatus as claimed in claim 3, wherein the impedances comprises an impedance having a larger impedance value and an impedance having a smaller impedance value.

5. The apparatus as claimed in claim 4, wherein the mixer IIP3 controller controls the IIP3 by selecting the impedance having the larger impedance value when the mixer IIP3 information has the lower value, and selecting the impedance having the smaller impedance value when the mixer IIP3 information has the higher value.

6. The apparatus as claimed in claim 3, wherein the baseband chip provides the mixer IIP3 control information through a Serial Peripheral Interface (SPI) signal.

7. A method for control of Input 3^{rd} order Intercept Point (IIP3) in a multi-mode multi-band wireless transceiver, the method comprising the steps of:
(a) determining a current mode and transmission power level of the wireless transceiver by a baseband chip;
(b) providing mixer IIP3 control information according to the determined current mode and transmission power level; and
(c) controlling the IIP3 of a mixer based on the IIP3 control information by a mixer IIP3 controller.

8. The method as claimed in claim 7, further comprising storing the mixer IIP3 control information according to the determined current mode and transmission power level by the baseband chip.

9. The method as claimed in claim 8, wherein the mixer IIP3 control information according to the transmission power level and the mode has a lower value when the wireless transceiver does not employ a Frequency Division Duplexing (FDD) mode or when the transceiver employs the FDD mode and is in an idle state in which the wireless transceiver does not operate, and has a higher value when the wireless transceiver employs the FDD mode and the transmission power is large.

10. The method as claimed in claim 7, wherein step (c):
controlling the IIP3 by selecting an impedance having a greater impedance value when the mixer IIP3 information has a lower value; and
controlling the IIP3 by selecting an impedance having a lower impedance value when the mixer IIP3 information has a greater value.

11. The method as claimed in claim 7, wherein the baseband chip provides the mixer IIP3 control information through a Serial Peripheral Interface (SPI) signal.

12. An apparatus for control of Input 3^{rd} order Intercept Point (IIP3) in a wireless transceiver, the apparatus comprising:
a mixer for down-converting an incoming wireless signal which has been low noise-amplified;
a baseband chip for providing mixer IIP3 control information according to transmission power level of the wireless transceiver; and
a mixer IIP3 controller for controlling the IIP3 of the mixer based on the IIP3 control information.

13. The apparatus as claimed in claim 12, wherein the mixer comprises:
at least two impedances having different impedance values; and
a switch for selecting one of the impedances.

14. The apparatus as claimed in claim 13, wherein the mixer IIP3 controller controls the IIP3 by selecting the impedance having the greater impedance value when the mixer IIP3 information has the lower value, and selecting the impedance having the lower impedance value when the mixer IIP3 information has the greater value.

15. The apparatus as claimed in claim 12, wherein the baseband chip provides the mixer IIP3 control information through a Serial Peripheral Interface (SPI) signal.

16. A method for control of Input 3^{rd} order Intercept Point (IIP3) in a wireless transceiver, the method comprising the steps of:
(a) determining transmission power level of the wireless transceiver by a baseband chip;
(b) providing mixer IIP3 control information according to the determined transmission power level; and
(c) controlling the IIP3 of a mixer based on the IIP3 control information by a mixer IIP3 controller.

17. The method as claimed in claim 16, further comprising storing the mixer IIP3 control information according to the determined transmission power level by the baseband chip.

18. The method as claimed in claim 16, wherein step (c) comprises
controlling the IIP3 by selecting an impedance having a greater impedance value when the mixer IIP3 information has a lower value; and
controlling the IIP3 by selecting an impedance having a lower impedance value when the mixer IIP3 information has a greater value.

19. The method as claimed in claim 16, wherein the baseband chip provides the mixer IIP3 control information through a Serial Peripheral Interface (SPI) signal.
